(19) United States
(12) Patent Application Publication
(10) Pub. No.: US 2007/0268926 A1
(43) Pub. Date: Nov. 22, 2007

(54) System and Method for Allocating Memory Resources in a Switching Environment

(75) Inventors: Yukihiro Nakagawa, Cupertino, CA (US); Takeshi Shimizu, Sunnyvale, CA (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 11/419,703

(22) Filed: May 22, 2006

(51) Int. Cl. H04L 12/54

(52) U.S. Cl. 370/428

(57) ABSTRACT

In particular embodiments of the present invention, a system for allocating memory resources in a switching environment is provided. In particular embodiments, the system includes a plurality of port modules each associated with a port. In these embodiments, the system also includes a data memory logically divided into a plurality of blocks. The system in these embodiments also includes a central agent configured to maintain a pool of credits associated with one or more of the blocks, each credit enabling data at a port module to be written to the corresponding block. The central agent is also configured to allocate one or more credits to a port module from the pool of credits, the allocated credit indicating that the corresponding block may be written to by the port module. The system in these embodiments further includes a research collection engine configured to determine whether a port has been disabled. If the port has been disabled, the research collection engine is configured to collect the one or more credits allocated to the port module associated with the disabled port and facilitate the release of the one or more collected credits to allow one or more other port modules to write to the blocks associated with the collected credits.

### TECHNICAL FIELD OF THE INVENTION

This invention relates generally to communication systems and more particularly to allocating memory resources in a switching environment.

### BACKGROUND OF THE INVENTION

High-speed serial interconnects have become more common in communications environments, and, as a result, the role that switches play in these environments has become more important. Traditional switches do not provide the scalability and switching speed typically needed to support these interconnects.

### SUMMARY OF THE INVENTION

Particular embodiments of the present invention may reduce or eliminate disadvantages and problems traditionally associated with shared memory resources in a switching environment.

In particular embodiments of the present invention, a system for allocating memory resources in a switching environment is provided. In particular embodiments, the system includes a plurality of port modules each associated with a port. In these embodiments, the system also includes a data memory logically divided into a plurality of blocks. The system in these embodiments also includes a central agent configured to maintain a pool of credits associated with one or more of the blocks, each credit enabling data at a port module to be written to the corresponding block. The central agent is also configured to allocate one or more credits to a port module from the pool of credits, the allocated credit indicating that the corresponding block may be written to by the port module. The system in these embodiments further includes a research collection engine configured to determine whether a port has been disabled. If the port has been disabled, the research collection engine is configured to collect the one or more credits allocated to the port module associated with the disabled port and facilitate the release of the one or more collected credits to allow one or more other port modules to write to the blocks associated with the collected credits.

Particular embodiments of the present invention provide one or more advantages. In particular embodiments, a switch can dynamically allocate memory resources among enabled port modules. In particular embodiments, the switch can collect memory resources allocated to disabled ports and re-allocate these resources to enabled port modules, reducing memory resource requirements for the switch and enabling more efficient handling of changes in load conditions at port modules. Particular embodiments may increase the throughput of a switch core, increase the speed at which packets are switched by the switch core, and/or reduce the fall-through latency of the switch core, which is important for cluster applications. Certain embodiments provide all, some, or none of these technical advantages, and certain embodiments provide one or more other technical advantages readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description, taken in conjunction with the accompanying drawings, in which:

FIG. 1 illustrates an example system area network;

FIG. 2 illustrates an example switch of a system area network;

FIG. 3 illustrates an example switch core of a switch;

FIG. 4 illustrates an example stream memory of a switch core logically divided into blocks;

FIG. 5 illustrates, in more detail, example components in the example switch core of FIG. 3;

FIG. 6A illustrates an example method for using an enabled port's allocated credits; and

FIG. 6B illustrates an example method for collecting the port-allocated credits of a disabled port.

### DESCRIPTION OF EXAMPLE EMBODIMENTS

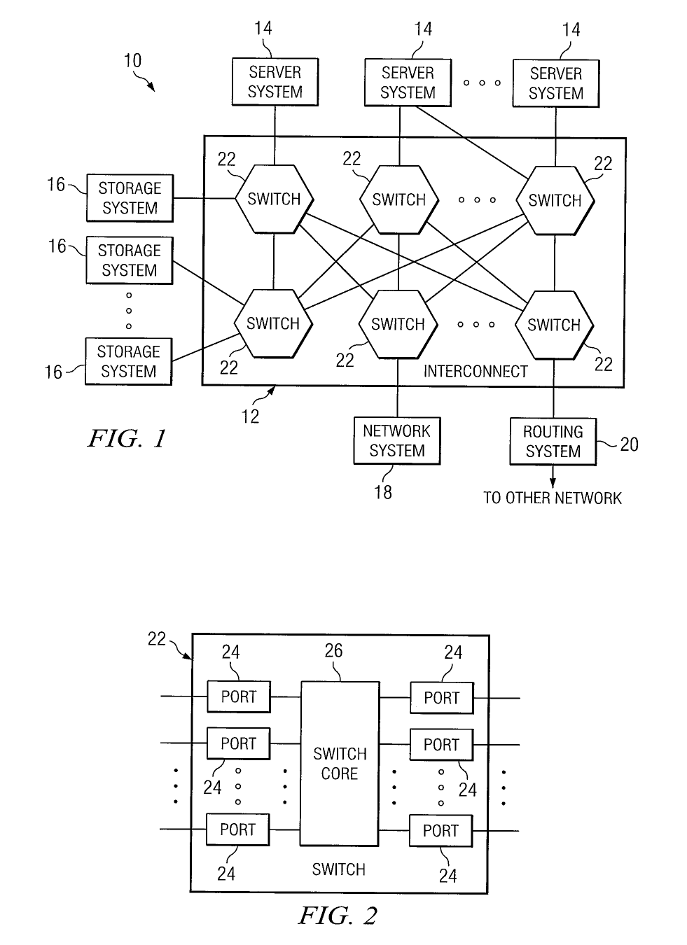

FIG. 1 illustrates an example system area network 10 that includes a serial or other interconnect 12 supporting communication among one or more server systems 14; one or more storage systems 16; one or more network systems 18; and one or more routing systems 20 coupling interconnect 12 to one or more other networks, which include one or more local area networks (LANs), wide area networks (WANs), or other networks. Server systems 14 each include one or more central processing units (CPUs) and one or more memory units. Storage systems 16 each include one or more channel adaptors, one or more disk adaptors, and one or more CPU modules. Interconnect 12 includes one or more switches 22, which, in particular embodiments, include Ethernet switches, as described more fully below. The components of system area network 10 are coupled to each other using one or more links, each of which includes one or more computer buses, local area networks (LANs), metropolitan area networks (MANs), wide area networks (WANs), portions of the Internet, or other wireline, optical, wireless, or other links. Although system area network 10 is described and illustrated as including particular components coupled to each other in a particular configuration, the present invention contemplates any suitable system area network including any suitable components coupled to each other in any suitable configuration.

FIG. 2 illustrates an example switch 22 of system area network 10. Switch 22 includes multiple ports 24 and a switch core 26. Ports 24 are each coupled to switch core 26 and a component of system area network 10 (such as a server system 14, a storage system 16, a network system 18, a routing system 20, or another switch 22). A first port 24 receives a packet from a first component of system area network 10 and communicates the packet to switch core 26 for switching to a second port 24, which communicates the packet to a second component of system area network 10. Reference to a packet can include a packet, datagram, frame, or other unit of data, where appropriate. Switch core 26 receives a packet from a first port 24 and switches the packet to one or more second ports 24, as described more fully below. In particular embodiments, switch 22 includes an Ethernet switch. In particular embodiments, switch 22 can switch packets at or near wire speed.

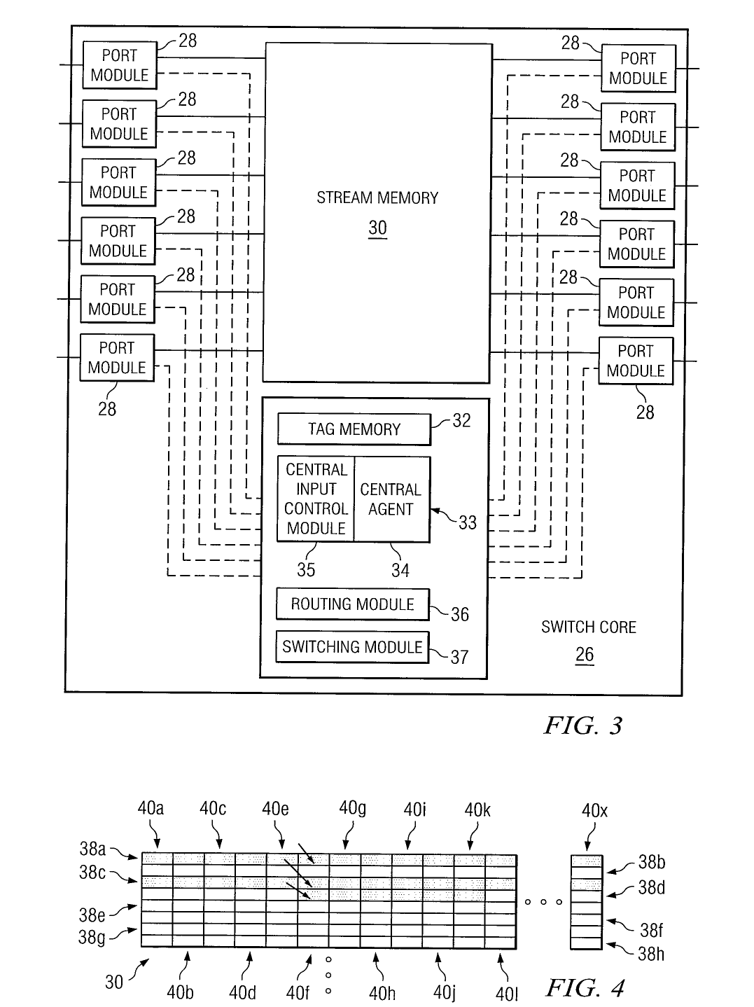

FIG. 3 illustrates an example switch core 26 of switch 22. Switch core 26 includes twelve port modules 28, stream memory 30, tag memory 32, input control and central agent (ICCA) 33, routing module 36, and switching module 37. The components of switch core 26 are coupled to each other using buses or other links. In particular embodiments, switch core 26 is embodied in a single IC. In a default mode of switch core 26, a packet received by switch core 26 from a first component of system area network 10 can be communicated from switch core 26 to one or more second components of system area network 10 before switch core 26 receives the entire packet. In particular embodiments, cut-through forwarding provides one or more advantages (such as reduced latency, reduced memory requirements, and increased throughput) over store-and-forward techniques. Switch core 26 can be configured for different applications. As an example and not by way of limitation, switch core 26 can be configured for an Ethernet switch 22 (which includes a ten-gigabit Ethernet switch 22 or an Ethernet switch 22 in particular embodiments); an INFINIBAND switch 22; a 3GIO switch 22; a HYPERTRANSPORT switch 22; a RAPID IO switch 22; a proprietary backplane switch 22 for storage systems 16, network systems 18, or both; or other switch 22.

A port module 28 provides an interface between switch core 26 and a port 24 of switch 22. Port module 28 is communicatively coupled to port 24, stream memory 30, tag memory 32, ICCA 33, routing table 36, and switching module 37. In particular embodiments, port module 28 includes both input logic (which is used for receiving a packet from a component of system area network 10 and writing the packet to stream memory 30) and output logic (which is used for reading a packet from stream memory 30 and communicating the packet to a component of system area network 10). As an alternative, in particular embodiments, port module 28 includes only input logic or only output logic. Reference to a port module 28 can include a port module 28 that includes input logic, output logic, or both, where appropriate. Port module 28 can also include an input buffer for inbound flow control. In an Ethernet switch 22, a pause function can be used for inbound flow control, which can take time to be effective. The input buffer of port module 28 can be used for temporary storage of a packet that is sent before the pause function stops incoming packets. Because the input buffer would be unnecessary if credits are exported for inbound flow control, as would be the case in an INFINIBAND switch 22, the input buffer is optional. In particular embodiments, the link coupling port module 28 to stream memory 30 includes two links: one for write operations (which include operations of switch core 26 in which data is written from a port module 28 to stream memory 30) and one for read operations (which include operations of switch core 26 in which data is read from stream memory 30 to a port module 28). Each of these links can carry thirty-six bits, making the data path between port module 28 and stream memory 30 thirty-six bits wide in both directions.

A packet received by a first port module 28 from a first component of system area network 10 is written to stream memory 30 from first port module 28 and later read from stream memory 30 to one or more second port modules 28 for communication from second port modules 28 to one or more second components of system area network 10. Reference to a packet being received by or communicated from a port module 28 can include the entire packet being received by or communicated from port module 28 or only a portion of the packet being received by or communicated from port module 28, where appropriate. Similarly, reference to a packet being written to or read from stream memory 30 can include the entire packet being written to or read from stream memory 30 or only a portion of the packet being written to or read from stream memory 30, where appropriate. Any port module 28 that includes input logic (an “input port module”) can write to stream memory 30, and any port module 28 that includes output logic (an “output port module”) can read from stream memory 30. In particular embodiments, a port module 28 may include both input logic and output logic and may thus be both an input port module and an output port module. In particular embodiments, the sharing of stream memory 30 by port modules 28 eliminates head-of-line blocking (thereby increasing the throughput of switch core 26), reduces memory requirements associated with switch core 26, and enables switch core 26 to more efficiently handle changes in load conditions at port modules 28.

Stream memory 30 of switch core 26 is logically divided into blocks 38, which are further divided into words 40, as illustrated in FIG. 4. A row represents a block 38, and the intersection of the row with a column represents a word 40 of block 38. In particular embodiments, stream memory 30 is divided into 1536 blocks 38, each block 38 includes twenty-four words 40, and a word 40 includes seventy-two bits. Although stream memory 30 is described and illustrated as being divided into a particular number of blocks 38 that are divided into a particular number of words 40 including a particular number of bits, the present invention contemplates stream memory 30 being divided into any suitable number of blocks 38 that are divided into any suitable number of words 40 including any suitable number of bits. Packet size can vary from packet to packet. A packet that includes as many bits as or fewer bits than a block 38 can be written to one block 38, and a packet that includes more bits than a block 38 can be written to more than one block 38, which need not be contiguous with each other.

When writing to or reading from a block 38, a port module 28 can start at any word 40 of block 38 and write to or read from words 40 of block 38 sequentially. Port module 28 can also wrap around to a first word 40 of block 38 as it writes to or reads from block 38. A block 38 has an address that can be used to identify block 38 in a write operation or a read operation, and an offset can be used to identify a word 40 of block 38 in a write operation or a read operation. As an example, consider a packet that is 4176 bits long. The packet has been written to fifty-eight words 40, starting at word 40f of block 38a and continuing to word 40k of block 38d, excluding block 38b. In the write operation, word 40f of block 38a is identified by a first address and a first offset, word 40f of block 38c is identified by a second address and a second offset, and word 40f of block 38d is identified by a third address and a third offset. The packet can also be read from stream memory 30 starting at word 40f of block 38a and continuing to word 40k of block 38d, excluding block 38b. In the read operation, word 40f of block 38a can be identified by the first address and the first offset, word 40f of block 38c can be identified by the second address and the second offset, and word 40f of block 38d can be identified by the third address and the third offset.

Tag memory 32 includes multiple linked lists that can each be used, by, for example, central input control module 35, to determine a next block 38 to which first port module 28 may write and, by, for example, second port modules 28, to determine a next block 38 from which second port modules 28 may read. Tag memory 32 also includes a linked list that can be used by central agent 34 to determine a next block 38 that can be made available to a port module 28 for a write operation from port module 28 to stream memory 30, as described more fully below. Tag memory 32 includes multiple entries, at least some of which each correspond to a block 38 of stream memory 30. Each block 38 of stream memory 30 has a corresponding entry in tag memory 32. An entry in tag memory 32 can include a pointer to another entry in tag memory 32, resulting in a linked list.

Entries in tag memory 32 corresponding to blocks 38 that are available to a port module 28 for write operations from port module 28 to stream memory 30 can be linked together such that a next block 38 to which a port module 28 may write can be determined using the linked entries. When a block 38 is made available to a port module 28 for write operations from port module 28 to stream memory 30, an entry in tag memory 32 corresponding to block 38 can be added to the linked list being used to determine a next block 38 to which port module 28 may write.

A linked list in tag memory 32 being used to determine a next block 38 to which a first port module 28 may write can also be used by one or more second port modules 28 to determine a next block 38 from which to read. As an example, consider the linked list described above. A first portion of a packet has been written from first port module 28 to first block 38, a second portion of the packet has been written from first port module 28 to second block 38, and a third and final portion of the packet has been written from first port module 28 to third block 38. An end mark has also been written to third block 38 to indicate that a final portion of the packet has been written to third block 38. A second port module 28 reads from first block 38 and, while second port module 28 is reading from first block 38, uses the pointer in the first entry to determine a next block 38 from which to read. The pointer refers second port module 28 to second block 38, and, when second port module 28 has finished reading from first block 38, second port module 28 reads from second block 38. While second port module 28 is reading from second block 38, second port module 28 uses the pointer in the second entry to determine a next block 38 from which to read. The pointer refers second port module 28 to third block 38, and, when second port module 28 has finished reading from second block 38, second port module 28 reads from third block 38. Second port module 28 reads from third block 38 and, using the end mark in third block 38, determines that a final portion of the packet has been written to third block 38. While a linked list in tag memory 32 cannot be used by more than one first port module 28 to determine a next block 38 to which to write, the linked list can be used by one or more second port modules 28 to determine a next block 38 from which to read.

Different packets can have different destinations, and the order in which packets make their way through stream memory 30 need not be first in, first out (FIFO). As an example, consider a first packet received and written to one or more first blocks 38 before a second packet is received and written to one or more second blocks 38. The second packet could be read from stream memory 30 before the first packet, and second blocks 38 could become available for other write operations before first blocks 38. In particular embodiments, a block 38 of stream memory 30 to which a packet has been written can be made available to a port module 28 for a write operation from port module 28 to block 38 immediately after the packet has been read from block 38 by all port modules 28 that are designated port modules 28 of the packet. A designated port module 28 of a packet includes a port module 28 coupled to a component of system area network 10, downstream from switch core 26, that is a final or intermediate destination of the packet.

Using credits to manage write operations may offer particular advantages. For example, using credits can facilitate cut-through forwarding by switch core 26, which reduces latency, increases throughput, and reduces memory requirements associated with switch core 26. Using credits to manage write operations can also eliminate head-of-line blocking and provide greater flexibility in the distribution of memory resources among port modules 28 in response to changing load conditions at port modules 28. A credit corresponds to a block 38 of stream memory 30 and can be used by a port module 28 to write to block 38. A credit can be allocated to a port module 28 from a pool of credits, which is managed by central agent 34. Reference to a credit being allocated to a port module 28 includes a block 38 corresponding to the credit being made available to port module 28 for a write operation from port module 28 to block 38, and vice versa.

A credit in the pool of credits can be allocated to any port module 28 and need not be allocated to any particular port module 28. A port module 28 can use only a credit that is available to port module 28 and cannot use a credit that is available to another port module 28 or that is in the pool of credits. A credit is available to port module 28 if the credit has been allocated to port module 28 and port module 28 has not yet used the credit. A credit that has been allocated to port module 28 is available to port module 28 until port module 28 uses the credit. A credit cannot be allocated to more than one port module 28 at a time, and a credit cannot be available to more than one port module 28 at the same time. In particular embodiments, when a first port module 28 uses a credit to write a packet to a block 38 corresponding to the credit, the credit is returned to the pool of credits immediately after all designated port modules 28 of the packet have read the packet from block 38.

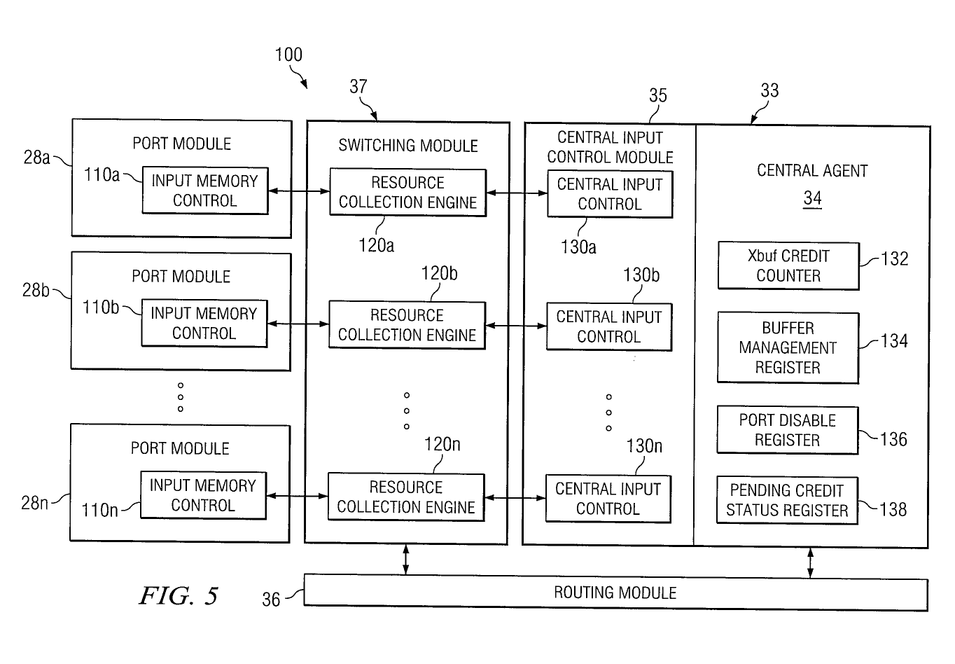

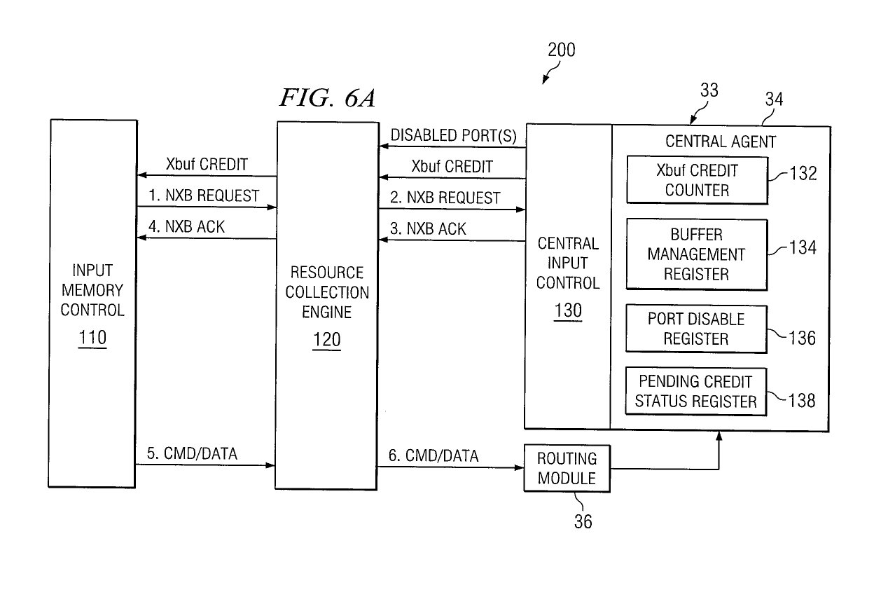

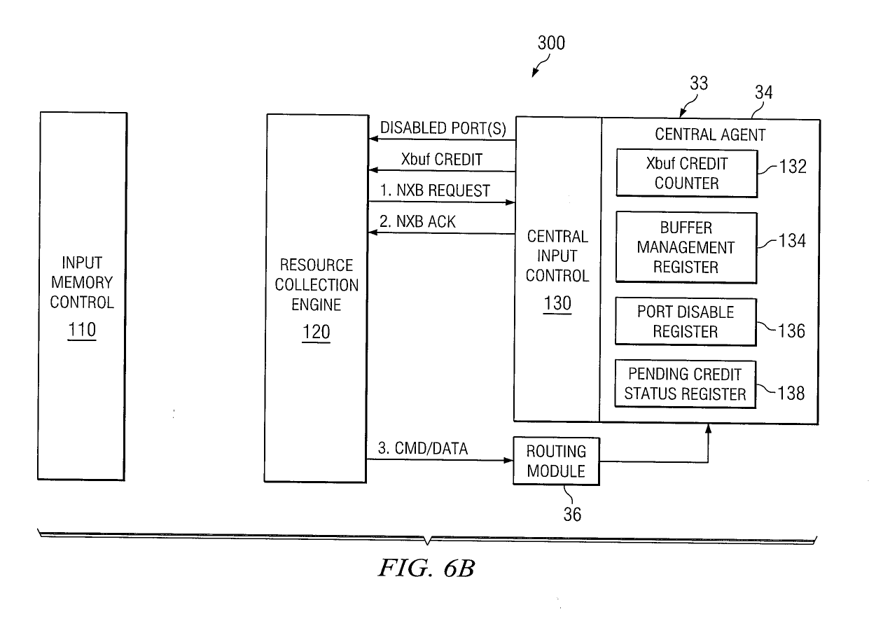

The advantages offered by the use of credits and their allocation to port modules 28 can be enhanced if the credits are utilized efficiently. Unfortunately, many typical switches do not utilize credits efficiently. Specifically, many of these typical switches misallocate memory resources by not releasing credits allocated to port modules 28 associated with ports that have been disabled. Since disabled ports no longer require allocated credits, continuing to allocate credits to the port modules 28 associated with these disabled ports prevents these credits (and their associated memory blocks) from being used by other port modules 28 that may be in need of additional credits. Thus, a need exists for components in a switch operable to release memory resources allocated to disabled ports. In particular embodiments, these components include ICCA 33, routing module 36, and switching module 37, described in more detail below, especially in conjunction with FIGS. 5 and 6.

ICCA 33 includes central agent 34 and central input control module 35. Central agent 34 is operable to allocate credits to port modules 28 from the pool of credits. As an example, central agent 34 can make an initial allocation of a predetermined number of credits to a port module 28. Central agent 34 can make this initial allocation of credits to port module 28, for example, at the startup of switch core 26 or in response to switch core 26 being reset. As another example, central agent 34 can allocate a credit to a port module 28 to replace another credit that port module 28 has used. In particular embodiments, when port module 28 uses a first credit, port module 28 notifies central agent 34 that port module 28 has used the first credit, and, in response to port module 28 notifying central agent 34 that port module 28 has used the first credit, central agent 34 allocates a second credit to port module 28 to replace the first credit, if, for example, the number of blocks 38 that are being used by port module 28 does not meet or exceed an applicable limit. In particular embodiments, central agent 34 can store port-allocated credits in central input control module 35 of ICCA 33 until requested by port modules 28 after the receipt of a packet.

It should be noted that reference to a block 38 that is being used by a port module 28 includes a block 38 to which a packet has been written from port module 28 and from which all designated port modules 28 of the packet have not read the packet. By replacing, up to an applicable limit, credits used by port module 28, the number of credits available to port module 28 can be kept relatively constant and, if the load conditions at port module 28 increase, more blocks 38 can be supplied to port module 28 in response to the increase in load conditions at port module 28. A limit may be applied in certain circumstances to the number of blocks used by port module 28, which may prevent port module 28 from using too many blocks 38 and thereby use up too many shared memory resources. The limit can be controlled dynamically based on the number of credits in the pool of credits. If the number of credits in the pool of credits decreases, the limit can also decrease. The calculation of the limit and the process according to which credits are allocated to port module 28 can take place out of the critical path of packets through switch core 26, which increases the switching speed of switch core 26.

A linked list in tag memory 32 can be used by central agent 34 to determine a next credit that can be allocated to a port module 28. The elements of the linked list can include entries in tag memory 32 corresponding to blocks 38 that in turn correspond to credits in the pool of credits. As an example, consider four credits in the pool of credits. A first credit corresponds to a first block 38, a second credit corresponds to a second block 38, a third credit corresponds to a third block 38, and a fourth credit corresponds to a fourth block 38. A first entry in tag memory 32 corresponding to first block 38 includes a pointer to second block 38, a second entry in tag memory 32 corresponding to second block 38 includes a pointer to third block 38, and a third entry in tag memory 32 corresponding to third block 38 includes a pointer to fourth block 38. Central agent 34 allocates the first credit to a port module 28 and, while central agent 34 is allocating the first credit to a port module 28, uses the pointer in the first entry to determine a next credit to allocate to a port module 28. The pointer refers central agent 34 to second block 38, and, when central agent 34 has finished allocating the first credit to a port module 28, central agent 34 allocates the second credit to a port module 28. While central agent 34 is allocating the second credit to a port module 28, central agent 34 uses the pointer in the second entry to determine a next credit to allocate to a port module 28. The pointer refers central agent 34 to third block 38, and, when central agent 34 has finished allocating the second credit to a port module 28, central agent allocates the third credit to a port module 28. While central agent 34 is allocating the third credit to a port module 28, central agent 34 uses the pointer in the third entry to determine a next credit to allocate to a port module 28. The pointer refers central agent 34 to fourth block 38, and, when central agent 34 has finished allocating the third credit to a port module 28, central agent allocates the fourth credit to a port module 28.

When a credit corresponding to a block 38 is returned to the pool of credits, an entry in tag memory 32 corresponding to block 38 can be added to the end of the linked list that central agent 34 is using to determine a next credit to allocate to a port module 28. As an example, consider the linked list described above. If the fourth entry is the last element of the linked list, when a fifth credit corresponding to a fifth block 38 is added to the pool of credits, the fourth entry can be modified to include a pointer to a fifth entry in tag memory 32 corresponding to fifth block 38. Because entries in tag memory 32 each correspond to a block 38 of stream memory 30, a pointer that points to a block 38 also points to an entry in tag memory 32.

When a port module 28 receives an incoming packet, port module 28 determines whether enough credits are available to port module 28 to write the packet to stream memory 30. Port module 28 may do so, for example, by reading a counter at central agent 34 indicating the number of credits available to the port module 28 to write. Alternatively, port module 28 may receive this information automatically from central agent 34. The information received by port module 28 is referred to below, in conjunction with FIGS. 5 and 6, as “Xbuf Credit,” and the counter at central agent 34 is referred to as “Xbuf Credit” counter 132. In particular embodiments, if enough credits are available to port module 28 to write the packet to stream memory 30, port module 28 can write the packet to stream memory 30 using one or more credits. In particular embodiments, if enough credits are not available to port module 28 to write the packet to stream memory 30, port module 28 can write the packet to an input buffer and later, when enough credits are available to port module 28 to write the packet to stream memory 30, write the packet to stream memory 30 using one or more credits. As an alternative to port module 28 writing the packet to an input buffer, port module 28 can drop the packet. In particular embodiments, if enough credits are available to port module 28 to write only a portion of the packet to stream memory 30, port module 28 can write to stream memory 30 the portion of the packet that can be written to stream memory 30 using one or more credits and write one or more other portions of the packet to an input buffer. Later, when enough credits are available to port module 28 to write one or more of the other portions of the packet to stream memory 30, port module 28 can write one or more of the other portions of the packet to stream memory 30 using one or more credits. In particular embodiments, delayed cut-through forwarding, like cut-through forwarding, provides one or more advantages (such as reduced latency, reduced memory requirements, and increased throughput) over store-and-forward techniques. Reference to a port module 28 determining whether enough credits are available to port module 28 to write a packet to stream memory 30 includes port module 28 determining whether enough credits are available to port module 28 to write the entire packet to stream memory 30, write only a received portion of the packet to stream memory 30, or write at least one portion of the packet to stream memory 30, where appropriate.

In particular embodiments, the length of an incoming packet cannot be known until the entire packet has been received. In these embodiments, a maximum packet size (according to an applicable set of standards) can be used to determine whether enough credits are available to a port module 28 to write an incoming packet that has been received by port module 28 to stream memory 30. According to a set of standards published by the Institute of Electrical and Electronics Engineers (IEEE), the maximum size of an Ethernet frame is 1500 bytes. According to a de facto set of standards, the maximum size of an Ethernet frame is nine thousand bytes. As an example and not by way of limitation, consider a port module 28 that has received only a portion of an incoming packet. Port module 28 uses a maximum packet size (according to an applicable set of standards) to determine whether enough credits are available to port module 28 to write the entire packet to stream memory 30. Port module 28 can make this determination by comparing the maximum packet size with the number of credits available to port module 28. If enough credits are available to port module 28 to write the entire packet to stream memory 30, port module 28 can write the received portion of the packet to stream memory 30 using one or more credits and write one or more other portions of the packet to stream memory 30 using one or more credits when port module 28 receives the one or more other portions of the packet.

As described above, central agent 34 can monitor the number of credits available to port module 28 using a counter, referred to as Xbuf Credit counter 132 in conjunction with FIGS. 5 and 6, and provide this information to port module 28 automatically or after port module 28 requests the information. When central agent 34 allocates a credit to port module 28, central agent 34 increments counter 132 by an amount, and, when port module 28 notifies central agent 34 that port module 28 has used a credit, central agent 34 decrements counter 132 by an amount. The current value of counter 132 reflects the current number of credits available to port module 28, and central agent 34 can use counter 132 to determine whether to allocate one or more credits to port module 28. Central agent 34 can also monitor the number of blocks 38 that are being used by port module 28 using a second counter (not illustrated). When port module 28 notifies central agent 34 that port module 28 has written to a block 38, central agent increments the second counter by an amount and, when a block 38 to which port module 28 has written is released and a credit corresponding to block 38 is returned to the pool of credits, central agent decrements the second counter by an amount. Additionally or alternatively, central input control module 35 may also monitor the number of credits available to port modules 28 using its own counter(s).

The number of credits that are available to a port module 28 can be kept constant, and the number of blocks 38 that are being used by port module 28 can be limited. The limit can be changed in response to changes in load conditions at port module 28, one or more other port module 28, or both. In particular embodiments, the number of blocks 38 that are being used by a port module 28 is limited according to a dynamic threshold that is a function of the number of credits in the pool of credits. An active port module 28, in particular embodiments, includes a port module 28 that is using one or more blocks 38. Reference to a port module 28 that is using a block 38 includes a port module 28 that has written at least one packet to stream memory 30 that has not been read from stream memory 30 to all designated port modules 28 of the packet. A dynamic threshold can include a fraction of the number of credits in the pool of credits calculated using the following formula, in which α equals the number of port modules 28 that are active and ρ is a parameter:

$$\frac{ρ}{1 + ( ρ \times α )}$$

A number of credits in the pool of credits can be reserved to prevent central agent 34 from allocating a credit to a port module 28 if the number of blocks 38 that are each being used by a port module 28 exceeds an applicable limit, which can include the dynamic threshold described above. Reserving one or more credits in the pool of credits can provide a cushion during a transient period associated with a change in the number of port modules 28 that are active. The fraction of credits that are reserved is calculated using the following formula, in which α equals the number of active port modules 28 and ρ is a parameter:

$$\frac{1}{1 + ( ρ \times α )}$$

According to the above formulas, if one port module 28 is active and ρ is two, central agent 34 reserves one third of the credits and may allocate up to two thirds of the credits to port module 28; if two port modules 28 are active and ρ is one, central agent 34 reserves one third of the credits and may allocate up to one third of the credits to each port module 28 that is active; and if twelve port modules 28 are active and ρ is 0.5, central agent 34 reserves two fourteenths of the credits and may allocate up to one fourteenth of the credits to each port module 28 that is active. Although a particular limit is described as being applied to the number of blocks 38 that are being used by a port module 28, the present invention contemplates any suitable limit being applied to the number of blocks 38 that are being used by a port module 28.

In particular embodiments, central input control module 35 of ICCA 33 stores the credits allocated to particular port modules 28 by central agent 34 and can manage port-allocated credits using a linked list. Central input control module 35 can forward port-allocated credits to a particular, enabled ort module 28 after the port module 28 requests a credit from central input control module 35. In particular embodiments, port-allocated credits are forwarded by central input control module 35 to enabled port modules 38 through switching module 37. As described further below, when a port is disabled, central input control module 35 and switching module 37 may work together to collect and release the credits allocated to the disabled port. Although the illustrated embodiment includes central input control module 35 in ICCA 33, in alternative embodiments, central input control module 35 may reside in any suitable location, such as, for example, in central agent 34 or in port modules 28 themselves.

When a first port module 28 associated with an enabled port writes a packet to stream memory 30, first port module 28 can communicate to routing module 36 through switching module 37 information from the header of the packet (such as one or more destination addresses) that routing module 36 can use to identify one or more second port modules 28 that are designated port modules 28 of the packet. First port module 28 can also communicate to routing module 36 an address of a first block 38 to which the packet has been written and an offset that together can be used by second port modules 28 to read the packet from stream memory 30. Routing module 36 can identify second port modules 28 using one or more routing tables and the information from the header of the packet and, after identifying second port modules 28, communicate the address of first block 38 and the offset to each second port module 28, which second port module 28 can add to an output queue, as described more fully below. In particular embodiments, routing module 36 can communicate information to second port modules 28 through ICCA 33.

In particular embodiments, switching module 37 is coupled between port modules 28 and both routing module 36 and ICCA 33 to facilitate the communication of information between port modules 28 and ICCA 33 or routing module 36 when a port is enabled. When a port is disabled, switching module 37 is operable to facilitate the collection and release of port-allocated credits associated with the disabled port. Switching module 37, and specifically its role in the collection and release of port-allocated credits, is described in more detail below in conjunction with FIGS. 5 and 6. It should be noted that, although a single switching module 37 is illustrated, switching module 37 may represent any suitable number of switching modules. In addition, switching module 37 may be shared by any suitable number of port modules 28. Furthermore, the functionality of switching module 37 may be incorporated in one or more of the other components of the switch.

An output port module 28 can include one or more output queues that are used to queue packets that have been written to stream memory 30 for communication out of switch core 26 through port module 28. When a packet is written to stream memory 30, the packet is added to an output queue of each designated port module 28 of the packet. As an example, an output queue of a designated port module 28 can correspond to a combination of a level of quality of service (QoS) and a source port module 28 (although different or other variables may be used). As an example, consider a switch core 26 that provides three levels of QoS and includes four port modules 28 including both input logic and output logic. A first port module 28 includes nine output queues: a first output queue corresponding to the first level of QoS and a second port module 28; a second output queue corresponding to the first level of QoS and a third port module 28; a third output queue corresponding to the first level of QoS and a fourth port module 28; a fourth output queue corresponding to the second level of QoS and second port module 28; a fifth output queue corresponding to the second level of QoS and third port module 28; a sixth output queue corresponding to the second level of QoS and fourth port module 28; a seventh output queue corresponding to the third level of QoS and second port module 28; an eighth output queue corresponding to the third level of QoS and third port module 28; and a ninth output queue corresponding to the third level of QoS and fourth port module 28. A packet that has been written to stream memory 30 is added to the first output queue of first port module 28 if (1) the packet has been written to stream memory 30 from second port module 28, (2) first port module 28 is a designated port module 28 of the packet, and (3) the level of QoS of the packet is the first level of QoS. A packet that has been written to stream memory 30 is added to the fifth output queue of first port module 28 if (1) the packet has been written to stream memory 30 from third port module 28, (2) first port module 28 is a designated port module 28 of the packet, and (3) the level of QoS of the packet is the second level of QoS. A packet that has been written to stream memory 30 is added to the ninth output queue of first port module 28 if (1) the packet has been written to stream memory 30 from fourth port module 28, (2) first port module 28 is a designated port module 28 of the packet, and (3) the level of QoS of the packet is the third level of QoS. The three other port modules 28 in the example may have analogous output queue configurations.

Besides input port number and QoS, other additional or alternative variables may be used to formulate output queues. For example, queues may correspond to logical input ports instead of or in addition to physical input ports. Each logical port may be associated with two or more physical input ports, and information received from the two or more physical input ports may be identified as belonging to a logical input port if the information is somehow related. For example, in networks where link aggregation is used, packets received at two or more ports of a switch may be associated with the same source and thus should be tracked to one logical port instead of separate physical input ports. Output queues may also or alternatively correspond to other packet identifiers, such as, for example, source IP address, destination IP address, TCP/UDP source port, TCP/UDP destination port, and/or VLAN identifier. In this way, queues may correspond more closely to particular flows or partitions. In particular embodiments, output queues may be reconfigurable, depending on network needs.

An output queue of a port module 28 includes a register of port module 28 and, if there is more than one packet in the output queue, one or more entries in a memory structure of port module 28, as described below. A port module 28 includes a memory structure that can include one or more linked lists that port module 28 can use, along with one or more registers, to determine a next packet to read from stream memory 30. The memory structure includes multiple entries, at least some of which each correspond to a block 38 of stream memory 30. Each block 38 of stream memory 30 has a corresponding entry in the memory structure. An entry in the memory structure can include a pointer to another entry in the memory structure, resulting in a linked list. A port module 28 also includes one or more registers that port module 28 can also use to determine a next packet to read from stream memory 30. A register includes a read pointer, a write pointer, and an offset. The read pointer can point to a first block 38 to which a first packet has been written, the write pointer can point to a first block 38 to which a second packet (which could be the same packet as or a packet other than the first packet) has been written, and the offset can indicate a first word 40 to which the second packet has been written. Because entries in the memory structure each correspond to a block 38 of stream memory 30, a pointer that points to a block 38 also points to an entry in the memory structure.

Port module 28 can use the read pointer to determine a next packet to read from stream memory 30 (corresponding to the “first” packet above). Port module 28 can use the write pointer to determine a next entry in the memory structure to which to write an offset. Port module 28 can use the offset to determine a word 40 of a block 38 at which to start reading from block 38, as described further below. Port module 28 can also use the read pointer and the write pointer to determine whether more than one packet is in the output queue. If output queue is not empty and the write pointer and the read pointer both point to the same block 38, there is only one packet in the output queue. If there is only one packet in the output queue, port module 28 can determine a next packet to read from stream memory 30 and read the next packet from stream memory 30 without accessing the memory structure.

If a first packet is added to the output queue when there are no packets in the output queue, (1) the write pointer in the register is modified to point to a first block 38 to which the first packet has been written, (2) the offset is modified to indicate a first word 40 to which the first packet has been written, and (3) the read pointer is also modified to point to first block 38 to which the first packet has been written. If a second packet is added to the output queue before port module 28 reads the first packet from stream memory 30, (1) the write pointer is modified to point to a first block 38 to which the second packet has been written, (2) the offset is written to a first entry in the memory structure corresponding to first block 38 to which the first packet has been written and then modified to indicate a first word 40 to which the second packet has been written, and (3) a pointer in the first entry is modified to point to first block 38 to which the second packet has been written. The read pointer is left unchanged such that, after the second packet is added to the output queue, the read pointer still points to first block 38 to which the first packet has been written. As described more fully below, the read pointer is changed when port module 28 reads a packet in the output queue from stream memory 30. If a third packet is added to the output queue before port module 28 reads the first packet and the second packet from stream memory 30, (1) the write pointer is modified to point to a first block 38 to which the third packet has been written, (2) the offset is written to a second entry in the memory structure corresponding to first block 38 to which the second packet has been written and modified to indicate a first word 40 to which the third packet has been written, and (3) a pointer in the second entry is modified to point to first block 38 to which the third packet has been written. The read pointer is again left unchanged such that, after the third packet is added to the output queue, the read pointer still points to first block 38 to which the first packet has been written.

Port module 28 can use the output queue to determine a next packet to read from stream memory 30. As an example, consider the output queue described above in which there are three packets. In the register, (1) the write pointer points to first block 38 to which the third packet has been written, (2) the offset indicates first word 40 to which the third packet has been written, and (3) the read pointer points to first block 38 to which the first packet has been written. The first entry in the memory structure includes (1) an offset that indicates first word 40 to which the first packet has been written and (2) a pointer that points to first block 38 to which the second packet has been written. The second entry in the memory structure includes (1) an offset that indicates first word 40 to which the second packet has been written and (2) a pointer that points to first block 38 to which the third packet has been written.

Port module 28 compares the read pointer with the write pointer and determines, from the comparison, that there is more than one packet in the output queue. Port module 28 then uses the read pointer to determine a next packet to read from stream memory 30. The read pointer refers port module 28 to first block 38 of the first packet, and, since there is more than one packet in the output queue, port module 28 accesses the offset in the first entry indicating first word 40 to which the first packet has been written. Port module 28 then reads the first packet from stream memory 30, using the offset in the first entry, starting at first block 38 to which the first packet has been written. If the first packet has been written to more than one block 38, port module 28 can use a linked list in tag memory 32 to read the first packet from memory, as described above.

While port module 28 is reading the first packet from stream memory 30, port module 28 copies the pointer in the first entry to the read pointer, compares the read pointer with the write pointer, and determines, from the comparison, that there is more than one packet in the output queue. Port module 28 then uses the read pointer to determine a next packet to read from stream memory 30. The read pointer refers port module 28 to first block 38 of the second packet, and, since there is more than one packet in the output queue, port module 28 accesses the offset in the second entry indicating first word 40 to which the second packet has been written. When port module 28 has finished reading the first packet from stream memory 30, port module 28 reads the second packet from stream memory 30, using the offset in the second entry, starting at first block 38 to which the second packet has been written. If the second packet has been written to more than one block 38, port module 28 can use a linked list in tag memory 32 to read the second packet from memory, as described above.

While port module 28 is reading the second packet from stream memory 30, port module 28 copies the pointer in the second entry to the read pointer, compares the read pointer with the write pointer, and determines, from the comparison, that there is only one packet in the output queue. Port module 28 then uses the read pointer to determine a next packet to read from stream memory 30. The read pointer refers port module 28 to first block 38 of the third packet, and, since there is only one packet in the output queue, port module 28 accesses the offset in the register indicating first word 40 to which the third packet has been written. When port module 28 has finished reading the second packet from stream memory 30, port module 28 reads the third packet from stream memory 30, using the offset in the register, starting at first block 38 to which the third packet has been written. If the third packet has been written to more than one block 38, port module 28 can use a linked list in tag memory 32 to read the third packet from memory, as described above.

If a port module 28 includes more than one output queue, an algorithm can be used for arbitration among the output queues. Arbitration among multiple output queues can include determining a next output queue to use to determine a next packet to read from stream memory 30. Arbitration among multiple output queues can also include determining how many packets in a first output queue to read from stream memory 30 before using a second output queue to determine a next packet to read from stream memory 30. The present invention contemplates any suitable algorithm for arbitration among multiple output queues. As an example and not by way of limitation, according to an algorithm for arbitration among multiple output queues of a port module 28, port module 28 accesses output queues that are not empty in a series of rounds. In a round, port module 28 successively accesses the output queues in a predetermined order and, when port module 28 accesses an output queue, reads one or more packets in the output queue from stream memory 30. The number of packets that port module 28 reads from an output queue in a round can be the same as or different from the number of packets that port module 28 reads from each of one or more other output queues of port module 28 in the same round. In particular embodiments, the number of packets that can be read from an output queue in a round is based on a quantum value that defines an amount of data according to which more packets can be read from the output queue if smaller packets are in the output queue and fewer packets can be read from the output queue if larger packets are in the output queue, which can facilitate fair sharing of an output link of port module 28.

As discussed above, the advantages offered by the use of credits and their allocation to port modules 28 can be enhanced if the credits are utilized efficiently. Unfortunately, many typical switches misallocate memory resources by allocating memory resources to an enabled port and then failing to release these resources if the pot is disabled. Thus, a need exists for components in a switch operable to allocate memory resources to an enabled port and release these resources if the port is disabled.

FIG. 5 illustrates, in more detail, example components 100 in the example switch core of FIG. 3. Components 100 include port modules 28, switching module 37, ICCA 33 and routing module 36. Components 100 can be utilized in particular embodiments by switch core 26 to make an initial allocation of credits to each port module 28 that is used. If a port is enabled, components 100 can be further utilized to send port-allocated credits to the port modules 28 associated with the enabled port after the port module 28 receives an incoming packet and requests the credits. If a port is disabled, components 100 can be utilized to collect the port-allocated credits associated with the disabled port and return these credits to, for example, the credit pool for use by enabled ports. If a disabled port is then enabled again, components 100 can reallocate credits to the enabled port. Components 100 may thus allow for greater efficiency and flexibility in the allocation of memory resources.

In particular embodiments, a port module 28 may be unused, enabled, or disabled. No credits are allocated to unused ports, either in the initial allocation or in later allocations made by central agent 34. Typical switches allow for ports to be designated unused or used and thus allow for some resource preservation. However, many of these switches do not distinguish between enabled and disabled ports among the “used” ports, leading to inefficiency in memory resource use and inflexibility in switch design.

In the example switch of FIG. 5, the used port modules 28 may include enabled or disabled ports, and memory resources are allocated differently depending on the designation. Initially, all used port modules 28 may be enabled, and credits may be allocated to these port modules 28 in an initial allocation at, for example, the startup of switch core 26 or in response to switch core 26 being reset. Later, a port may be disabled, and the credits associated with the disabled port may be collected and released for use by other enabled ports. For example, network management software could disable a port if the network management software were to receive information that a link in the network associated with that port were down. Port enablement and disablement may be performed directly at the switch or by network management software.

In the illustrated embodiment, central agent 34 is operable to make an initial allocation of credits to each port module 28 associated with a used port. In particular embodiments, central agent 34 may store these port-allocated credits in the central input control 130 associated with the particular port module 28. Central agent 34 is operable to make the initial allocation of credits to port module 28, for example, at the startup of switch core 26 or in response to switch core 26 being reset.

After the initial allocation of credits, each port module 28 is operable to begin requesting port-allocated credits to write incoming packets to stream memory. Each port module 28 comprises an input memory control 110 operable to receive a packet, request port-allocated credits from its associated central input control 130, and using the received port-allocated credits, write the packet to stream memory 30. After identifying the block to which input memory control 110 will write the packet (based on the received credit), input memory control 110 is further operable to communicate control information associated with the packet and/or its location in stream memory 30 to routing module 36. Control information may include, for example, a destination address, VLAN ID, and other packet header information, and can allow routing module 36 to make control decisions. Control decisions may include, for example, using a table to determine, based on the control data, the output port modules 28 associated with the packet. Control decisions may also include forwarding an address of a first block to which the packet has been written and an offset that together can be used by output port modules 28 to read the packet from stream memory 30. In this case, where a port is enabled and input memory control 110 has forwarded control information, routing module 36 is operable to make these forwarding decisions.

As illustrated in the example embodiment, switching module 37 may comprise any suitable number of resource collection engines 120, each corresponding to a port module 28 and an input control 130 of ICCA 33. Switching module may act as an intermediary between port modules 28 and ICCA 33 and routing module 36. Thus, information communicated between port modules 28 and ICCA 33 or routing module 36 may pass through switching module 37. Switching module 37 can also track the number of credits allocated to each port module 28 (for example, by reading counter 132 in central agent 34, described below) and can also determine whether a particular port has been disabled (for example, by reading port disable register 136 in central agent 34).

When a port is enabled, a resource collection engine 120 in switching module 37 associated with the enabled port is operable to receive requests for credits made by the input memory control 110 of the associated port module 28 and forward these requests to an associated central input control 130 of ICCA 33. Resource collection engine 120 is further operable to receive acknowledgments made by the associated central input control 130 of ICCA 33 and forward these acknowledgments to the input memory control 110 of the associated port module 28. Thus, for example, resource collection engine 120a in switching module 37 may receive a credit request made by input memory control 110a in port module 28a and forward the request to central input control 130a in central input control module 35. Resource collection engine 120a may then receive an acknowledgment, including a credit, made by central input control 130a and forward the acknowledgment to input memory control 110a, allowing port module 28a to write a packet to stream memory. After port module 28a identifies the block(s) in stream memory to which it will write the packet, port module 28a may forward control information to resource collection engine 120a, describing for example the packet's destination address, its location in stream memory, or any other suitable packet identification information. Resource collection engine 120a may forward this information to routing module 36 for suitable routing of the packet. In this case, where the port is enabled and input memory control 110 has forwarded control information through resource collection engine 120, suitable routing may include making forwarding decisions. Forwarding decisions may include identifying the output port modules 28 associated with the packet, using a table, for example, and forwarding the location in stream memory 30 where the packet has been written to the identified output port modules 28.

When a port is disabled, the resource collection engine 120 associated with the disabled port is operable to communicate with an associated central input control 130 of ICCA 33, described below, to collect and facilitate the release of the credits allocated to the port module 28 of the disabled port. A credit may be released, for example, to the shared credit pool for use by other ports, as described further below. To collect the port-allocated credits, a resource collection engine 120 associated with the disabled port is operable to request port-allocated credits from the associated central input control 130. After receiving an acknowledgment, including the requested credit, the resource collection engine 120 is further operable to send control information associated with the credit to routing module 36, thereby facilitating the release of the credit and its associated memory block for use by other port modules. Because central agent 34 does not allocate any more credits to a port module 28 after its associated port has been disabled, switching module 37 may thus collect and facilitate the release of all of the credits allocated to the port module.

It should be noted that, although in the illustrated embodiment, there is one resource collection engine 120 associated with each port module 28 and central input control 130, any suitable number of resource collection engines 120 may correspond to any suitable number of port modules 28 and central input controls 130. For example, one resource collection engine 120 may be shared by more than one port module 28 and central input control 130. In addition, switching module 37 may comprise any suitable number of resource collection engines 120.

ICCA 33 comprises central agent 34 and central input control module 35, described above in conjunction with FIG. 3. Central agent 34 is operable to allocate credits for each port module 28 and store the allocated credits in central input control module 35. In particular embodiments, central agent 34 may include one or more counters and one or more registers. For example, as described above, central agent 34 may comprise an Xbuf Credit counter 132 for each port module. Xbuf Credit counter 132 comprises any suitable counter operable to count the credits available to a particular port module 28. In particular embodiments, this value may be exported to or otherwise accessed by switching module 37 and by the input memory control 110 of the particular port module 28 associated with counter 132. Central agent 34 may also include a buffer management register 134 that reflects whether resource collection has been enabled for the switch, a port disable register 136 that reflects which switch port(s) have been disabled, and a pending credit status register 138 that reflects whether any request for a credit is pending at ICCA 33 for a particular port. In the illustrated embodiment, central agent 34 is also operable to receive control decisions from routing module 36 and interpret these control decisions appropriately, as discussed further below. It should be noted that central agent 34 may comprise any suitable number of counters and registers, and counter 132 and registers 134, 136, and 138 may reside in any suitable location.

Central input control module 35 may include one or more central input controls 130. In the illustrated embodiment, each central input control 130 is associated with the input memory control 110 of one port module 28. However, in alternative embodiments, a central input control 130 may be shared by two or more input memory controls 110. Each central input control 130 may be operable to store the credits allocated to its associated port module 28 by central agent 34, receive requests for port-allocated credits from the associated port module's input memory control 110, and send acknowledgments including the requested credits to the associated input memory control 110. In this way, central input controls 130 are operable to manage the provision of port-allocated credits to the input memory control 110 of each associated port module 28. In particular embodiments, each central input control 130 may use a linked list, as described above, to provide credits to its associated port module 28. It should be noted that, as discussed above, in the illustrated embodiment, communication between central input controls 130 and input memory controls 110 of port modules 28 passes through switching module 37.

Routing module 36 may comprise any suitable routing module operable to receive control information from an enabled port module 28 that has written a packet to stream memory, and use the control information to make control decisions. When an enabled port module 28 has used one or more credits to write a packet to stream memory 30, control decisions made by routing module 36 may include, for example, using a table to determine, based on the control information, the output port modules 28 associated with the packet and forwarding an address of a first block to which the packet has been written and an offset that together can be used by second port modules 28 to read the packet from stream memory 30. Routing module 36 is further operable to forward any other suitable control information associated with the packet, allowing output port modules 28 to queue the packet appropriately. In particular embodiments, such as the illustrated embodiment, routing module 36 is operable to forward control information to output port modules 28 through ICCA 33. In alternative embodiments, routing module 36 may be operable to forward control information in any suitable manner.

When a port is disabled and the associated resource collection engine 120 is facilitating the release of port-allocated credits, routing module 36 is operable to receive control information from the resource collection engine 120 (instead of the port module 28, as when the associated port is enabled) and use the control information to make control decisions. Control information may include, for example, information associated with a credit allocated to the disabled port. Control decisions may include facilitating the release of the credit from allocation to the disabled port in order to, for example, return the credit to the shared credit pool for allocation to other enabled ports. In particular embodiments, routing module 36 may forward its control decisions to ICCA 33 for suitable release of the port-allocated credits. Suitable release may include, for example, placing the credit in question in a drop queue, thereby returning the credit to the shared credit pool. As discussed above, central agent 34 does not allocate additional credits to the disabled port module 28 during this process of credit collection and release.

FIG. 6A illustrates an example method 200 for using an enabled port's allocated credits. In the first step, not illustrated, central agent 34 may make an initial allocation of credits to each input port module 28. Central agent 34 may make the initial allocation of credits, for example, at the startup of switch core 26 or in response to switch core 26 being reset. Central agent 34 may send port-allocated credits to the central input control 130 associated with the particular port module 28 to which the credits have been allocated for storage.

After the initial allocation of credits, port module 28 may receive an incoming packet. After port module 28 receives the packet, input memory control 110 of port module 28 may request an additional credit from its associated central input control 130 in ICCA 33. The request, represented by “NXB Request” in the illustrated embodiment, passes through the associated resource collection engine 120 in switching module 37 before reaching the associated central input control 130. The associated central input control 130 in ICCA 33 receives the request, identifies the next credit to allocate to the port (using, for example, a linked list), and sends an acknowledgment that includes the next credit to the input memory control 110. The acknowledgment, represented by “NXB Ack” in the illustrated embodiment, passes through the associated resource collection engine 120 before reaching the requesting input memory control 110. After receiving the credit, input memory control 110 may then identify the block in stream memory 30 associated with the received credit to which to write incoming packet information. Input memory control 110 may then write the packet information to the block at any suitable time.

After identifying the block(s) in stream memory 30 to which input memory control 110 will write the incoming packet information, input memory control 110 sends control information associated with the packet, represented by “CMD/DATA” in the illustrated embodiment, to routing module 36 through resource collection engine 120. Control information may include, for example, the packet's destination port, its location in stream memory, or any other suitable packet identification information such as, for example, a virtual local access network (VLAN) identification. This control information allows routing module 36 to make suitable control decisions, such as forwarding decisions. As discussed above, forwarding decisions may include identifying the output port modules 28 associated with the packet, using a table, for example, and forwarding the location in stream memory 30 where the packet has been written to the identified output port modules 28. Routing module 36 may also forward any other suitable packet information, allowing output port modules 28 to queue, read, and transmit the packet appropriately. In particular embodiments, such as the illustrated embodiment, routing module 36 may forward control decisions to output port modules 28 through ICCA 33. In alternative embodiments, routing module 36 may forward control decisions in any other suitable manner. According to method 200, an enabled port can request, receive, and use its allocated credits to write incoming packet information to stream memory 30.

As discussed above, resource collection engine 120 can read Xbuf Credit counter 132 in ICCA 33 (or otherwise receive Xbuf Credit information) to determine the number of credits allocated to the associated port module. This information is represented by the “Xbuf Credit” message in the illustrated embodiment. In particular embodiments, resource collection engine 120 may also pass this information to the associated input memory control 110 at port module 28. Input memory control 110 may use this information, for example, to compare the size of a received packet to the number of available credits and request for an additional allocation of credits if needed.

As discussed above, resource collection engine 120 at switching module 37 can read the port disable register in ICCA 33 (or otherwise receive this information) to determine whether the particular port associated with resource collection engine 120 has been disabled. This information is represented by “Disabled port(s)” in the illustrated embodiment. If the port associated with the resource collection engine 120 has not been disabled, resource collection engine 120 allows communication to continue between input memory control 110 of port module 28 and ICCA 33, as described above. If, however, the port associated with the resource collection engine 120 has been disabled, resource collection engine 120 begins collecting credits, as described below.

FIG. 6B illustrates an example method 300 for collecting the port-allocated credits of a disabled port. In the first step, not illustrated, a previously-enabled port(s) that has been allocated an initial number of credits is disabled, and, in particular embodiments, the port module 28 associated with the disabled port may no longer receive packets or request credits. A port may be disabled for any suitable reason and in any suitable manner, such as, for example, directly at the switch or by network management software. After the port is disabled, the port disable register 136 in ICCA 33 reflects that the particular port has been disabled. The resource collection engine 120 associated with the disabled port reads port disable register 136, represented by “Disabled port(s)” in the illustrated embodiment, and begins collecting credits allocated to that port. It should be noted that, in particular embodiments, before a port is disabled, resource collection must be enabled in the buffer management register 134 in ICCA 33 in order to allow credits allocated to the disabled port to be collected and released.

To begin collecting credits, the resource collection engine 120 residing in switching module 37 and associated with the disabled port may request a credit from the associated central input control 130 in ICCA 33. The request is represented in the illustrated embodiment by “NXB Request.” The associated central input control 130 in ICCA 33 receives the request, identifies the next credit that has been allocated for the port (using, for example, a linked list), and sends an acknowledgment that includes the credit to the associated resource collection engine 120. The acknowledgment is represented by “NXB Ack” in the illustrated embodiment. Unlike in FIG. 6A, resource collection engine 120 does not forward NXB Ack to input memory control 110, and no packet information is written to the block corresponding to the received credit. Instead, resource collection engine 120 uses the NXB Ack information to generate control information, represented by “CMD/DATA” in the illustrated embodiment, and sends this information to routing module 36. Unlike in FIG. 6A, this control information identifies that the credit is to be released, allowing routing module 36 to facilitate the release of the credit from allocation to the disabled port. After routing module 36 receives this information, routing module 36 may make control decisions that facilitate the release of the credit, for example, by returning the credit to the shared credit pool. In the illustrated embodiment, routing module 36 sends its control decisions to ICCA 33. After receiving routing module's control decisions, ICCA 33, based at least in part on these control decisions, may release the credit, by, for example, placing the credit in question in a drop queue, thereby returning the credit to the shared credit pool and allowing central agent 34 to allocate the associated memory resource to other enabled ports. It should be noted that, during this process, neither ICCA 33 nor any other part of switch core 26 allocates additional credits to the disabled port to, for example, replace the released credits; otherwise, the goal of collecting memory resources from the disabled port and reallocating these resources more efficiently could be compromised.

This process of credit collection and release continues until there are no more port-allocated credits to collect for the disabled port. To determine that no more port-allocated credits remain, resource collection engine 120 of switching module 37 may read the Xbuf Credit counter 132 in ICCA 33 (or otherwise receive Xbuf Credit information). If no more port-allocated credits remain, resource collection engine 120 may stop making credit requests. ICCA 33 may also use counter 132 to determine that no more port-allocated credits remain and that credit collection is complete. Optionally, ICCA 33 may also confirm the completion of the resource collection by reading pending credit status register 138, which would indicate that no request for a credit was pending at ICCA 33 for the disabled port. If the disabled port were to be subsequently enabled, central agent 34 in ICCA 33 would begin to supply credits to the central input control 130 of the enabled port. The input memory control 110 of the enabled port's port module 28 would then begin to request credits, as described above with reference to FIG. 6A.

Modifications, additions, or omissions may be made to the systems and methods described without departing from the scope of the disclosure. The components of the systems and methods described may be integrated or separated according to particular needs. Moreover, the operations of the systems and methods described may be performed by more, fewer, or other components without departing from the scope of the present disclosure.

Although the present disclosure has been described with several embodiments, sundry changes, substitutions, variations, alterations, and modifications can be suggested to one skilled in the art, and it is intended that the disclosure encompass all such changes, substitutions, variations, alterations, and modifications falling within the spirit and scope of the appended claims.

What is claimed is:

1. A system for collecting memory resources in a switching environment, the system comprising:
a plurality of port modules each associated with a port;
a data memory logically divided into a plurality of blocks;
a central agent configured to:
maintain a pool of credits associated with one or more of the blocks, each credit enabling data at a port module to be written to the corresponding block; and
allocate one or more credits to a port module from the pool of credits, the allocated credit indicating that the corresponding block may be written to by the port module; and
a research collection engine configured to:
determine whether a port has been disabled; and
if the port has been disabled:
collect the one or more credits allocated to the port module associated with the disabled port; and
facilitate the release of the one or more collected credits to allow one or more other port modules to write to the blocks associated with the collected credits.

2. The system of claim 1, further comprising:
a routing module configured to:
receive control information from the resource collection engine, the control information identifying the credit to be released;
make a control decision based on the control information received, the control decision indicating that the credit is to be released to the pool of credits; and
communicate the control decision to the central agent, wherein the central agent is further configured to receive the control decision and release the credit from allocation to the port module associated with the disabled port.

3. The system of claim 1, wherein:
collecting the one or more credits allocated to the port module associated with the disabled port comprises requesting and receiving the one or more credits allocated to the port module; and
facilitating the release of the one or more credits comprises forwarding control information associated with the received credit to the central agent, the central agent configured to release the credit based in part on the control information.

4. The system of claim 1, wherein the central agent is further configured to reallocate one or more credits to the port module associated with the disabled port if the disabled port is enabled.

5. The system of claim 1, wherein the central agent further comprises a central input control associated with the disabled port, the central input control configured to store the one or more credits allocated to the port module associated with the disabled port and to send the credits to the resource collection engine to allow the resource collection engine to collect the credits.

6. The system of claim 5, wherein the central input control is configured to send the credits to the resource collection engine using a linked list.

7. The system of claim 1, wherein the central agent no longer allocates new credits to a port module after the port associated with the port module has been disabled.

8. The system of claim 1, wherein the system is embodied in a single integrated circuit (IC).

9. The system of claim 1, wherein the resource collection engine is further configured to, if the port has not been disabled, enable the port module associated with the port to write data to the blocks associated with the credits allocated to the port module.

10. A method for collecting memory resources in a switching environment, the method comprising:
maintaining a pool of credits associated with one or more blocks, each block representing a logical division of data memory, each credit enabling data at a port module to be written to the corresponding block, each port module associated with a port of a switch;
allocating one or more credits to a port module from the pool of credits, the allocated credit indicating that the corresponding block may be written to by the port module;
determining whether a port has been disabled; and
if the port has been disabled:
collecting the one or more credits allocated to the port module associated with the disabled port; and
facilitating the release of the one or more collected credits to allow one or more other port modules to write to the blocks associated with the collected credits.

11. The method of claim 10, wherein:
collecting the one or more credits allocated to the port module associated with the disabled port comprises requesting and receiving the one or more credits allocated to the port module; and
facilitating the release of the one or more credits comprises forwarding control information associated with the received credit, receiving the control information, and releasing the credit based in part on the control information.

12. The method of claim 10, further comprising reallocating one or more credits to the port module associated with the disabled port if the disabled port is enabled.

13. The method of claim 10, further comprising no longer allocating new credits to a port module after the port associated with the port module has been disabled.

14. The method of claim 10, further comprising, if the port has not been disabled, enabling the port module associated with the port to write data to the blocks associated with the credits allocated to the port module.

15. Logic encoded in a computer-readable medium, the logic operable when executed by a computer to:
maintain a pool of credits associated with one or more blocks, each block representing a logical division of data memory, each credit enabling data at a port module to be written to the corresponding block, each port module associated with a port of a switch;
allocate one or more credits to a port module from the pool of credits, the allocated credit indicating that the corresponding block may be written to by the port module;
determine whether a port has been disabled; and
if the port has been disabled:
collect the one or more credits allocated to the port module associated with the disabled port; and
facilitate the release of the one or more collected credits to allow one or more other port modules to write to the blocks associated with the collected credits.

16. The logic of claim 15, wherein:
to collect the one or more credits allocated to the port module associated with the disabled port comprises requesting and receiving the one or more credits allocated to the port module; and
to facilitate the release of the one or more credits comprises forwarding control information associated with the received credit, receiving the control information, and releasing the credit based in part on the control information.

17. The logic of claim 15, further operable when executed by a computer to reallocate one or more credits to the port module associated with the disabled port if the disabled port is enabled.

18. The logic of claim 15, further operable when executed by a computer to no longer allocate new credits to a port module after the port associated with the port module has been disabled.

19. The logic of claim 15, further operable when executed by a computer to, if the port has not been disabled, enable the port module associated with the port to write data to the blocks associated with the credits allocated to the port module.
